(19) United States
(12) Patent Application Publication
(10) Pub. No.: US 2009/0168836 A1
(43) Pub. Date: Jul. 2, 2009

(54) MICROMECHANICAL STRUCTURE HAVING A SUBSTRATE AND A THERMOELEMENT, TEMPERATURE SENSOR AND/OR RADIATION SENSOR, AND METHOD FOR MANUFACTURING A MICROMECHANICAL STRUCTURE

(76) Inventors: Holger Hoefer, Sonnenbuehl (DE); Axel Grosse, Pfullingen (DE)

Correspondence Address: KENYON & KENYON LLP, ONE BROADWAY, NEW YORK, NY, 10004, US

(21) Appl. No.: 12/097,891

(22) PCT Filed: Nov. 24, 2006
(86) PCT No.: PCT/EP06/68881

§ 371 Date: Sep. 15, 2008

(30) Foreign Application Priority Data
Dec. 21, 2005 (DE) 10 2005 061 148.6

(51) Int. Cl. G01J 5/02; B05D 3/00

(52) U.S. Cl. 374/121; 427/402

(57) ABSTRACT

A micromechanical structure, a temperature and/or radiation sensor, and a method for manufacturing a micromechanical structure are suggested, the micromechanical structure including a substrate and a thermoelement having a reference contact and a measuring contact, the substrate having a main substrate plane), the thermoelement having a first material between the reference contact and the measuring contact and a second material between the measuring contact and a further reference contact, either the first material being situated over the second material or the second material being situated over the first material between the reference contact and the measuring contact in a direction perpendicular to the main substrate plane.

### FIELD OF THE INVENTION

The present invention is directed to a micromechanical structure.

### BACKGROUND INFORMATION

A device for heat detection, in particular an infrared sensor, is described in German Patent Application DE 102 43 012 A1, in which a heat-sensing element is situated on a diaphragm of a substrate. A thermoelement in the form of a micromechanical thermopile, for example, is provided here as the heat-sensing element. Such thermoelements or thermopiles are typically based on a diaphragm principle, i.e., the hot contacts rest on a diaphragm, which is comparatively thin, for thermal and electrical decoupling. This has the serious disadvantage that the thermoelements have poor stability, flawed crack recognition, and low density.

### SUMMARY

An example micromechanical structure according to the present invention, example temperature and/or radiation sensor, and example method for manufacturing a micromechanical structure may have the advantage in relation thereto that the known disadvantages of the related art are avoided or at least reduced and nonetheless a comparatively compactly and cost-effectively manufacturable micromechanical structure is possible. It is particularly advantageous if a continuous diaphragm in the area of the thermoelement(s) of the micromechanical structure may be dispensed with. The two legs of the thermoelements do not lie adjacent to one another according to the present invention, i.e., generally in a plane parallel to the main substrate plane of the micromechanical structure, but rather tilted essentially 90° thereto, i.e., the legs lie vertically one on top of another in relation to the main substrate plane, so that a significantly reduced space requirement parallel to the main substrate plane results in comparison to the related art at a generally identical material cross section (in the direction of the main extension of the legs of the thermoelement) of the legs of a thermoelement (for example, a thickness of a polysilicon leg of a few micrometers to a few tens of micrometers, in particular approximately 10 μm, and a width of a few hundred nanometers to a few micrometers, in particular approximately 1.5 μm). The two legs of such a thermoelement have the significant advantage that because of their greater thickness in a direction perpendicular to the main substrate plane, there is a significantly higher structural stability to withstand mechanical stresses. In case of a defect, such as a crack, there is a direct effect on the electrical properties of the particular thermoelement, so that direct error recognition is possible. This dramatically increases the operational reliability of the micromechanical structure according to the present invention. The thickness of the legs of a thermopile, which is increased in comparison to the typical thermopile design, causes a significantly higher absorption of radiation heat and/or heat in general to be possible using the micromechanical structure according to the present invention, so that the necessity for an additional heat absorber is significantly reduced. The two legs are referred to in the following as the first and second material (namely as a function of whether they point from the reference contact to the measuring contact (first material) or from the measuring contact to a further or next reference contact (second material)) or also as the material proximal to or distal from the substrate (as a function of the construction of the thermoelement).

It is particularly preferable according to the present invention if the thermoelement extends between the reference contact and the measuring contact in a main extension direction at least in some sections parallel to the main substrate plane, the micromechanical structure also having multiple thermoelements, the thermoelements being provided at least partially or in some sections mechanically disconnected from one another perpendicular to the main extension direction. Such a thermopile according to the present invention, provided at least partially without a diaphragm, additionally avoids parasitic heat dissipation possibilities to a large extent.

It is particularly preferable if the measuring contacts of the thermoelements are provided generally freely suspended. Possibilities for parasitic heat dissipation are thus further reduced. Overall, the precision of the micromechanical structure as a temperature and/or radiation sensor may thus be increased. Furthermore, in a further specific embodiment of the present invention, the measuring contacts of the thermoelements may be provided connected to one another like a diaphragm parallel to the main substrate plane and/or the measuring contacts of the thermoelements may be provided mechanically connected to the substrate in a direction perpendicular to the main substrate plane. In this way, it is possible according to the present invention to achieve greater stability of the micromechanical structure. Furthermore, it is thus advantageously possible according to the present invention to reduce the number of process steps for manufacturing the micromechanical structure and thus to reduce the manufacturing costs of the micromechanical structure.

Furthermore, it may be preferable according to the present invention for the first material to include a semiconductor material and the second material to include a metal or for the first material to include a metal and the second material to include a semiconductor material or for the first material to include a preferably doped semiconductor material and the second material to include a doped semiconductor material different from the first material. In this way, it is advantageously possible according to the present invention to provide the material combinations, which are important for the function of the thermoelement, adapted to the particular intended purpose.

Furthermore, it may be preferable according to the present invention for the thermoelement to be provided running at an angle between the reference contact and the measuring contact in relation to the main substrate plane in such a way that the measuring contact is further away from the substrate than the reference contact. In this way, it is possible according to the present invention to implement better heat insulation by a greater distance of the measuring contact from the substrate material in a simple and cost-effective way without increased layer thicknesses during the manufacture of the micromechanical structure.

A further subject matter of the present invention is a temperature sensor and/or radiation sensor, which includes a micromechanical structure according to the present invention. Such a sensor is manufacturable particularly cost-effectively and robustly and also has particularly high sensitivity. A further subject matter of the present invention is a method for manufacturing a micromechanical structure according to the present invention or a temperature sensor and/or radiation sensor according to the present invention, the first material or the second material being applied as the material proximal to the substrate in a first step and the second material or the first material being applied, over the material proximal to the substrate, as the material distal from the substrate in a second step. In this way, according to the present invention it is possible comparatively simply to implement a thermoelement constructed in a direction perpendicular to the main substrate plane.

Furthermore, it may be preferable if a second insulation layer is applied at least partially between the first and the second materials between the application of the material proximal to the substrate and the application of the material distal from the substrate. In this way, it is particularly simple and cost-effective to implement the thermoelement constructed perpendicularly to the extension of the main substrate process.

Furthermore, it may be preferable according to the present invention if a first insulation layer is applied between the substrate and the material proximal to the substrate chronologically before the first step, the first insulation layer being at least partially removed again chronologically after the first step. Particularly simple insulation of the thermoelement in relation to the substrate is thus possible in that a sacrificial layer is provided between the substrate and the thermoelement, which is removed again in the further course of the manufacturing process.

Furthermore, it may be preferable according to the present invention if at least a part of the substrate adjoining the first insulation layer is removed during or after the removal of the first insulation layer. Further improvement of the insulation of the thermoelement in relation to the substrate is thus possible according to the present invention.

### BRIEF DESCRIPTION OF THE DRAWINGS

Exemplary embodiments of the present invention are illustrated in the figures and explained in greater detail below.

FIGS. 1 through 3 show a first specific embodiment of the micromechanical structure.

FIGS. 4 through 7 show a second specific embodiment of the micromechanical structure.

FIGS. 8 through 10 show a third specific embodiment of the micromechanical structure.

FIGS. 11 through 14 show a fourth specific embodiment of the micromechanical structure.

FIGS. 15 through 17 show a fifth specific embodiment of the micromechanical structure.

FIG. 18 shows precursor structures of a sixth specific embodiment of the micromechanical structure.

### DETAILED DESCRIPTION OF EXAMPLE EMBODIMENTS

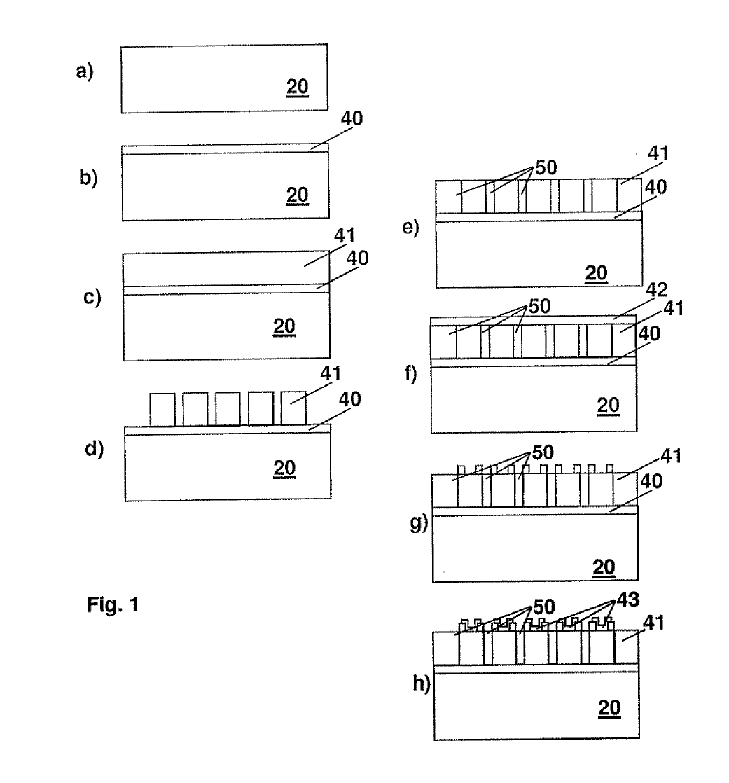

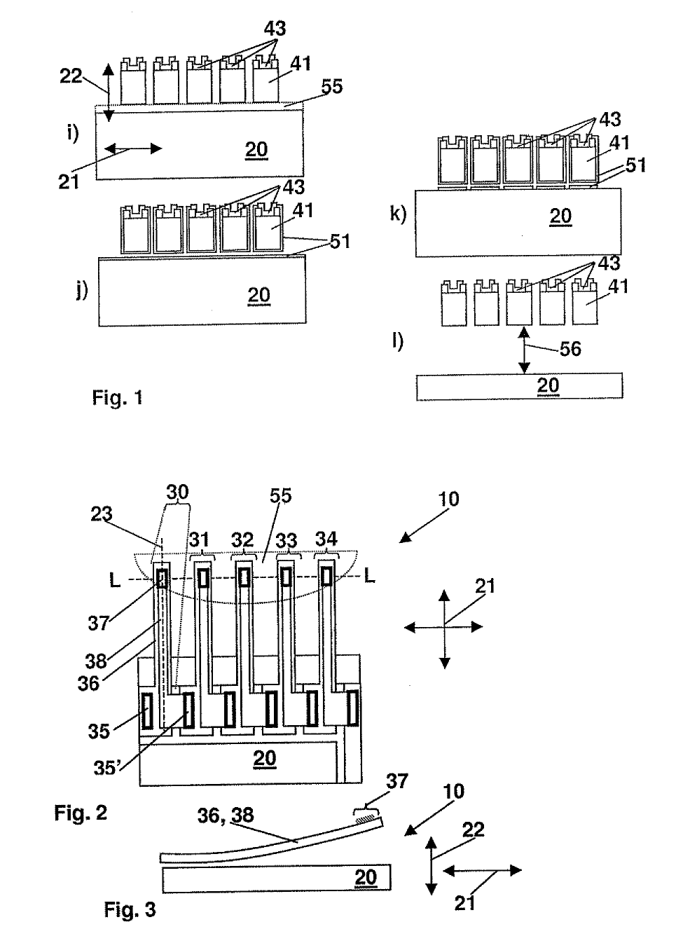

A first specific embodiment of micromechanical structure 10 according to the present invention is illustrated in FIGS. 1 through 3, only FIGS. 1i, 1l or 2 and 3 representing finished structure 10 and the remaining figures representing precursor structures of micromechanical structure 10. FIGS. 1a through 1l show sectional illustrations along section line L-L from FIG. 2. A coating having insulating material of a suitable thickness is applied (FIG. 1b) to a substrate 20 (FIG. 1a), which is provided in particular as a silicon substrate or as another semiconductor substrate. The insulating material is also referred to in the following as first insulation layer 40 in particular and is provided as silicon oxide or a similar material, in particular as a semiconductor oxide or a semiconductor nitride, for example. A material 41 proximal to substrate 20 is applied to first insulation layer 40 (FIG. 1c), for example, in the form of doped polysilicon. A chemical-mechanical polishing step is subsequently performed in particular. Following this, structured etching of material 41 proximal to substrate 20 is performed (FIG. 1d). Following this, the etched-out intermediate spaces are filled up using an insulating material 50, such as oxide or silicon oxide, and the structure is planarized (FIG. 1e). Subsequently, in a further step, a layer made of insulating material, referred to in the following as second insulation layer 42, is applied, which may be etched selectively to the material of first insulation layer 40 according to the first specific embodiment (FIG. 1f). The material of second insulation layer 42 is a silicon nitride, for example, if the material of first insulation layer 40 is a silicon oxide. Second insulation layer 42 is then structured (FIG. 1g); a protection of the sensor edge also may remain. Subsequently, a metal-plating layer is applied as a material 43 distal from substrate 20 (FIG. 1h). In a further step, the material of first insulation layer 40 and material 50 are removed using an etching step (such as gas-phase etching) (FIG. 1i). A first variant of the first specific embodiment of micromechanical structure 10 is thus finished.

To increase the distance between substrate 20 and material 41 proximal to substrate 20, a passivation layer 51 may be applied in a further process step (FIG. 1j) for a further variant of the first specific embodiment, which is opened at specific points (cf. reference numeral 51a) in a further process step (FIG. 1k), for example, using an oxide-RIE etching step, so that subsequently selective etching of a part of substrate 20 may be performed without effects on the previously prepared parts of the micromechanical structure. Passivation layer 51 is subsequently removed again and a greater distance 56 results between substrate 20 and material 41 proximal to substrate 20 (FIG. 1l). The etching away of a part of substrate 20 in the step from FIG. 1l may be performed using a ClF₃ etching procedure or a XeF₂ etching procedure, for example.

The filling up of the etched-out intermediate spaces using insulating material (50) shown in FIG. 1e may also be performed using a polysilicon layer, if a passivation layer, made of oxide material, for example, has previously been applied to protect the structures of the later thermoelement (not shown). If an appropriate direct transition (of the polysilicon material) to substrate 20 is additionally produced, the steps shown in FIGS. 1j, 1k, and 1l are subsequently simplified.

A top view of the first variant or the second variant of the first specific embodiment of micromechanical structure 10 is shown in FIG. 2. Micromechanical structure 10 has a thermoelement 30, which has a reference contact 35, a measuring contact 37, and a first material 36 between reference contact 35 and measuring contact 37, as well as a second material 38 between measuring contact 37 and a further reference contact 35′ of a further thermoelement 31. First and second materials 36, 38 each form a leg of thermoelement 30 between reference contacts 35 or 35′ and measuring contact 37. According to an example embodiment of the present invention, legs 36, 38 are situated one on top of another in a direction 22 perpendicular to main substrate plane 21. Thus, in the example of FIG. 2, material 41 proximal to substrate 20 (FIG. 1) forms first material 36 and material 43 distal from substrate 20 (FIG. 1) forms second material 38. Thermoelement 30 and further thermoelement 31 and possibly multiple further thermoelements 32, 33, 34 are constructed in the same way or generally identically to thermoelement 30, but are situated adjacent to one another parallel to main substrate plane 21. In the variants of the first specific embodiment of micromechanical structure 10 shown in FIG. 2, measuring contacts 37 of thermoelements 30 through 34 may be provided mechanically connected to substrate 20 using a support structure 55 (only shown by dashed lines). Support structure 55 is implemented in particular according to the present invention in the form of a nitride layer below material 41 proximal to substrate 20 (particularly preferably a polysilicon material). In this way, it is possible that support structure 55 is not removed by the etching of first insulation layer 40 shown in FIG. 1i. The legs of thermoelements 30 through 34 and/or first or second material 36, 38 are provided at least partially freely suspended between support structure 55 and reference contacts 35, 35′. If support structure 55 is not provided, thermoelements 30 are situated generally completely freely suspended above substrate 20. It is clear that if support structure 55 is present, it must also be imagined in the sectional illustrations of FIGS. 1a through 1i (along section line L-L from FIG. 2). This is indicated by a dashed line in FIG. 1i.

A further variant of the first specific embodiment of micromechanical structure 10 is shown in a side view in FIG. 3. FIG. 3 is generally a sectional illustration along a main extension direction 23 of thermoelement 30. It may be seen that the side of measuring contact 37 of the legs of the thermoelements is bent away from substrate 20. This may be performed via an application of layers 41, 43 (material proximal to or distal from substrate 20) or using first or second material 36, 38 in such a way that mechanical tensions remain in these layers, which result in corresponding bending of the thermoelement or parts of thermoelement 30 away from substrate 20. In these variants of the first specific embodiment of micromechanical structure 10, the steps shown in FIGS. 1j, 1k, and 1l to increase the distance between substrate 20 and measuring contact 37 may be left out, because an appropriately greater distance has already been implemented by the sag of the thermoelement. However, the measures of bending away and increasing distance 56 by etching away parts of substrate 20 may also be combined with one another.

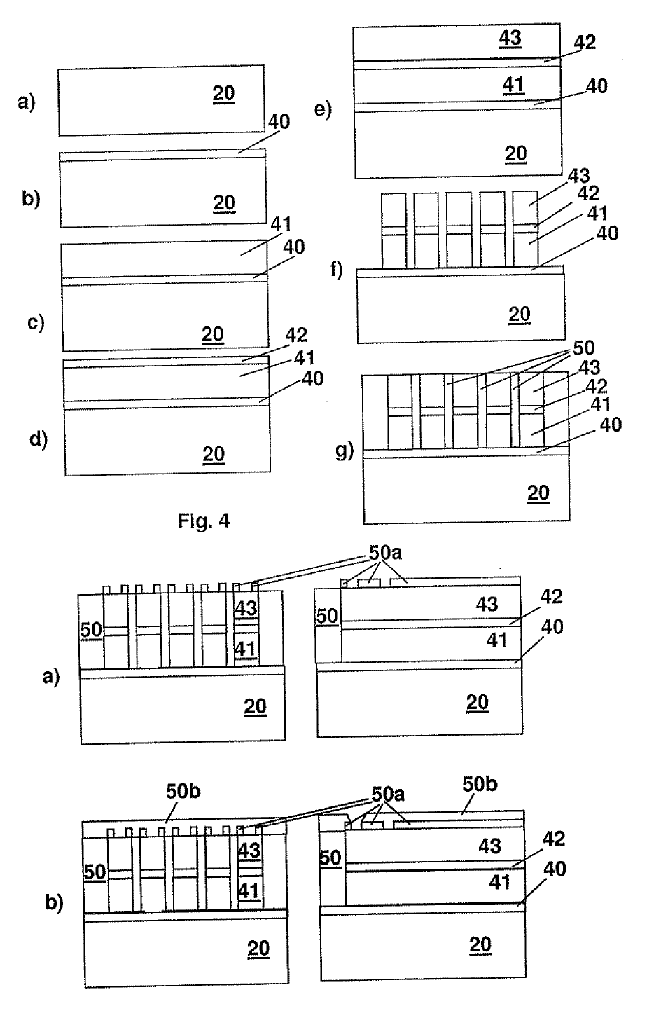

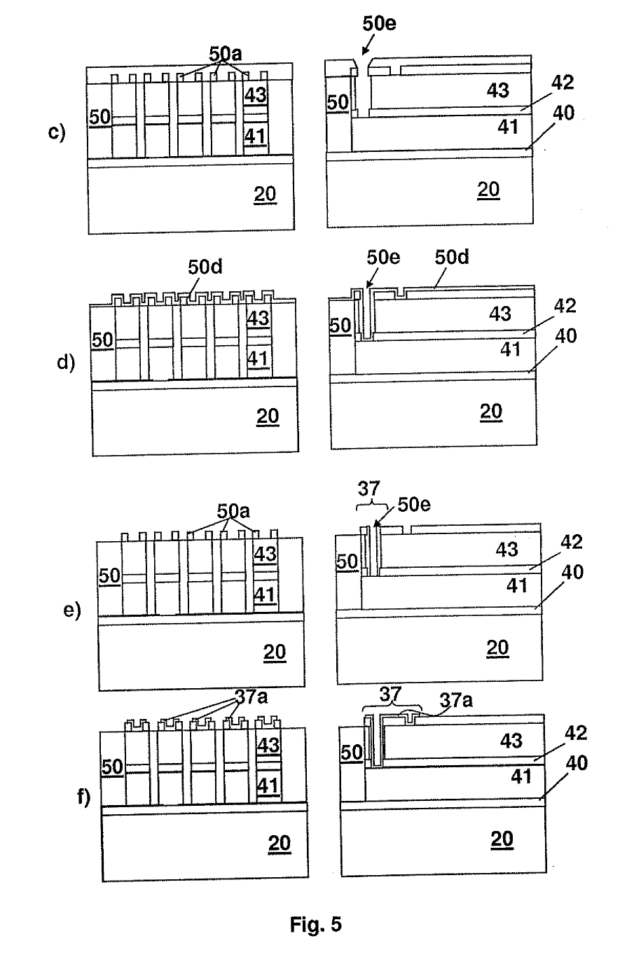

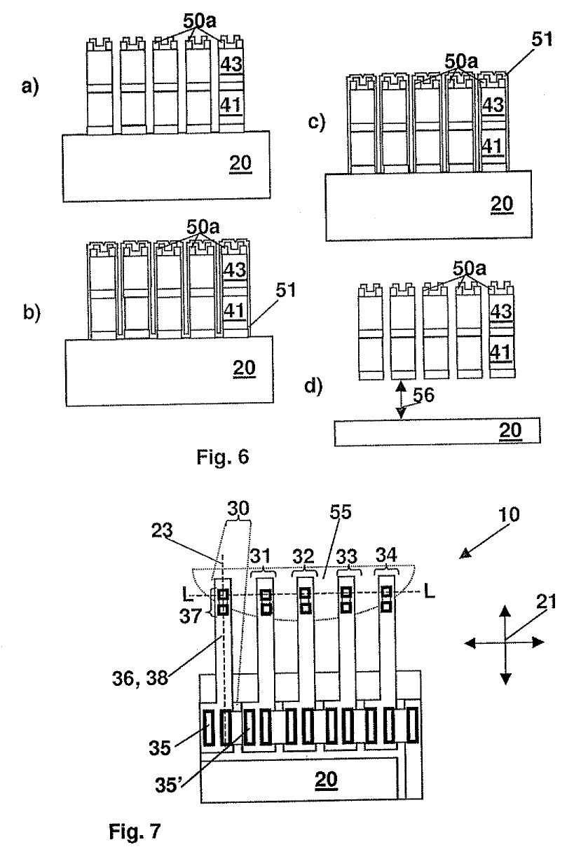

A second specific embodiment of micromechanical structure 10 according to the present invention is illustrated in FIGS. 4 through 7, only FIG. 7 or 6d representing finished structure 10 and the remaining figures representing precursor structures of micromechanical structure 10. FIGS. 4a through 4g, 5a through 5f, and 6a through 6d show sectional illustrations along section line L-L from FIG. 7, FIGS. 5a through 5f additionally showing sectional illustrations (right figure in each case) along main extension direction 23 of thermoelement 30 from FIG. 7. Similarly to the first specific embodiment (FIGS. 1 through 3), first insulation layer 40 (such as a silicon nitride layer) is also applied (FIG. 4b) to substrate 20 (FIG. 4a) and material 41 proximal to substrate 20 (FIG. 4c) is applied thereto in the second specific embodiment. This material is in particular a polysilicon material doped with a first type of charge carrier (i.e., either positive or negative). Subsequently, a chemical-mechanical polishing step is performed in particular. Second insulation layer 42, such as a silicon nitride, is deposited on material 41 proximal to substrate 20 (FIG. 4d). In contrast to the first specific embodiment, second insulation layer 42 does not have to be able to be etched selectively to first insulation layer 40. Material 43 distal from substrate 20 is deposited on second insulation layer 42 (FIG. 4e). This is a polysilicon material doped with a second type of charge carrier (i.e., either negative or positive) in particular. A chemical-mechanical polishing step is subsequently performed in particular. An etching step (FIG. 4f) is subsequently performed to structure both material 41 proximal to substrate 20 and also material 43 distal from substrate 20, for example, using a trench etching step. Subsequently, the etched-out intermediate spaces are filled up using insulating material 50, such as silicon oxide, and the structure is planarized—similarly to the first specific embodiment described for FIG. 1e—a passivation layer having subsequent polysilicon also being able to be used (FIG. 4g). A layer of a further insulating material 50a is then applied in structured form (FIG. 5a). Further insulating material 50a has to be able to be etched selectively in relation to insulating material 50. Using a lacquer layer 50b (FIG. 5b) and further etching through material 43 distal from substrate 20 and second insulation layer 42 (FIG. 5c), it is possible to implement measuring contact 37 using plating-through 50e. For this purpose, a passivation layer, e.g., an oxide layer 50d, is deposited for contact insulation (FIG. 5d) and removed in areas outside plating-through 50e (FIG. 5e), for example, using oxide-RIE etching. Contact metal plating 37a (for example, using an AlSiCu layer (aluminum-silicon-copper layer)), which implements measuring contact 37, electrically connects material 41 proximal to substrate 20 to material 43 distal from substrate 20 at low resistance (FIG. 5f). Using a gas-phase etching step in particular, insulating material 50 (which was applied in the method according to FIG. 4h) is removed (cf. FIG. 6a).

To set a predefinable distance 56 between material 41 proximal to substrate 20 and substrate 20 (cf. FIG. 6d), a passivation layer 51 is applied similarly to FIGS. 1j, 1k, and 1l (FIG. 6b) (following the removal of insulating material 50 according to FIG. 6a), passivation layer 51 is selectively removed (or “opened”, FIG. 6c), and subsequently selective etching of a part of substrate 20 is performed without effects on the previously prepared parts of micromechanical structure 10 (FIG. 6d), and finally passivation layer 51 is removed.

The micromechanical structure is illustrated in FIG. 7 analogously to FIG. 2 in a top view having section line L-L and main extension direction 23 of thermoelement 30. Reference contact 35, measuring contact 37 including plating-through 50e, as well as further thermoelements 31 through 34 are recognizable in a way similar to FIG. 2. For the sake of simplicity, a support structure 55 according to FIG. 2 is not shown in FIG. 7, but is also possible in a similar way.

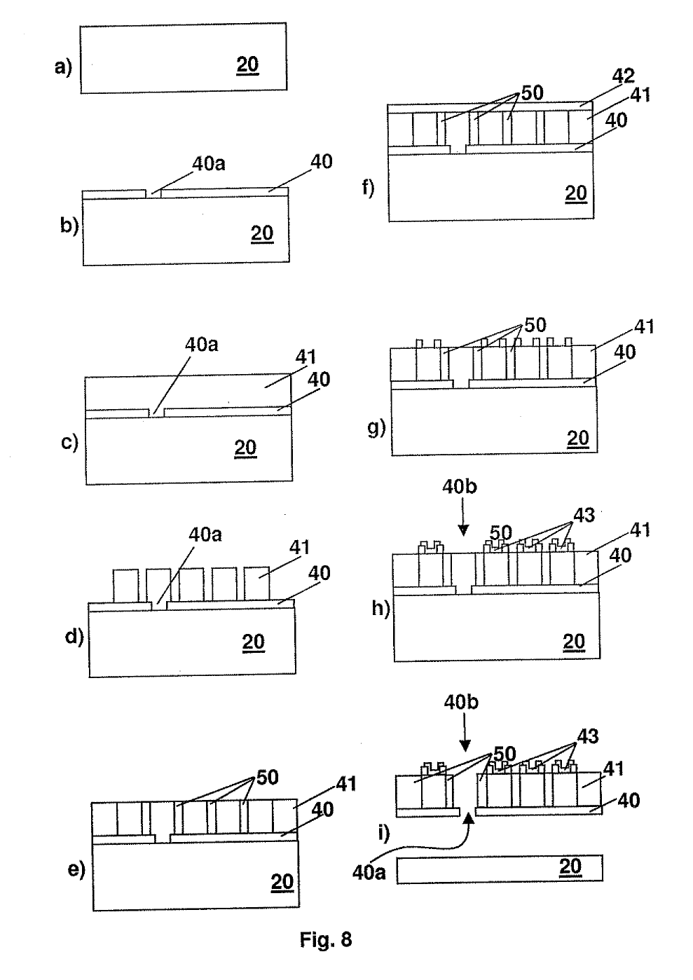

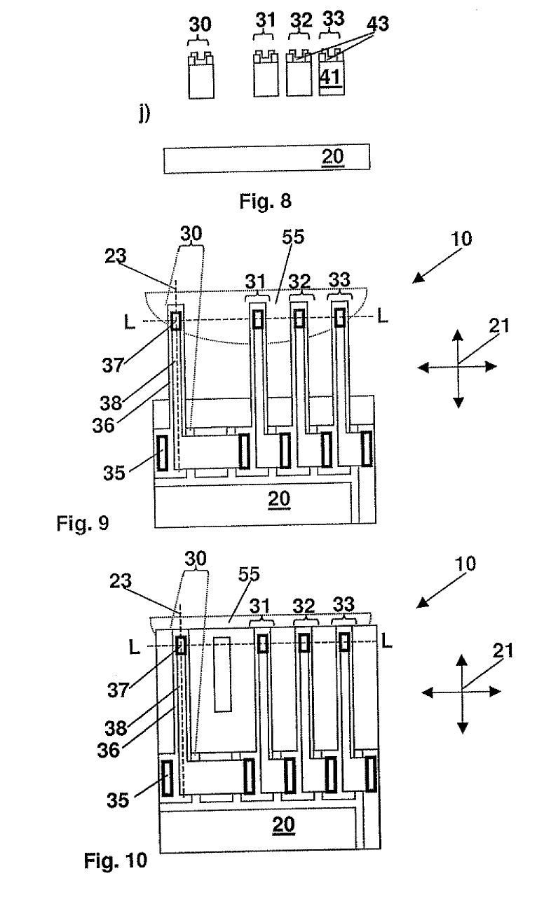

A third specific embodiment of micromechanical structure 10 according to the present invention is shown in FIGS. 8 through 10, only FIGS. 9, 10 or 8j, 8i representing finished structure 10 and the remaining figures representing precursor structures of micromechanical structure 10. FIGS. 8a through 8j show sectional illustrations along section line L-L from FIGS. 9 and/or 10. Corresponding to the first specific embodiment (FIGS. 1 through 3), first insulation layer 40 (FIG. 5b) is also applied to substrate 20 (FIG. 8a) in the third specific embodiment. In the third specific embodiment, first insulation layer 40 is applied in structured form in such a way that an opening remains in first insulation layer 40 at least one point 40a. Corresponding to the first specific embodiment (FIGS. 1 through 3), material 41 proximal to substrate 20 is also applied (FIG. 8c) to first insulation layer 40 (and in the area of opening 40a to substrate 20) in the third specific embodiment. This material is in particular a polysilicon material doped with a first type of charge carrier (i.e., either positive or negative). Subsequently, a chemical-mechanical polishing step is performed in particular. Similarly to the method steps according to the first specific embodiment (FIGS. 1d through 1h), in the third specific embodiment of micromechanical structure 10, there is also structured etching (FIG. 8d), filling up using insulating material 50 and planarization (FIG. 8e), application of second insulation layer 42 (FIG. 8f), its structuring (FIG. 8g), and application of the metal-plating layer as material 43 distal from substrate 20 (FIG. 8h).

Due to the interruption of first insulation layer 40 at point 40a, it is possible in the third specific embodiment to perform etching of a part of substrate 20 directly, because a continuous access 40b to material which may be etched exists for this purpose above point 40a (FIGS. 8h and 8i). For this purpose, for example, ClF₃ etching or XeF₂ etching is used. At this point in the process sequence, various thermoelements 30, 31, 32, 33 are still connected in the direction perpendicular to their main extension direction 23 (and parallel to main extension plane 21 of substrate 20), i.e., they form a continuous diaphragm in a certain way. This represents a variant of the third specific embodiment of micromechanical structure 10 and is shown in a top view in FIG. 10.

If the material parts (prior insulating material 50) connecting thermoelements 30, 31, 32, 33 are also removed in a further process step (FIG. 8j), for example, using gas-phase etching, a freestanding structure results for each of thermoelements 30, 31, 32, 33, which is shown in a top view in FIG. 9. Similarly to the first specific embodiment (FIGS. 2 and 7), a variant with or without support structure 55 is again possible (only shown by dashed line in FIGS. 9 and 10).

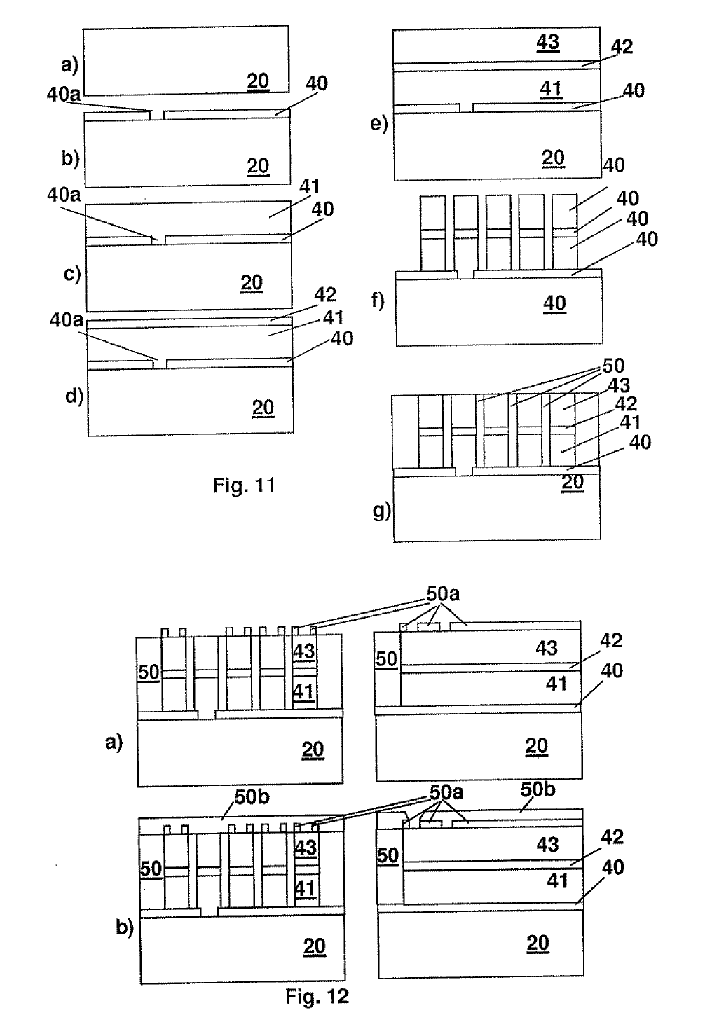

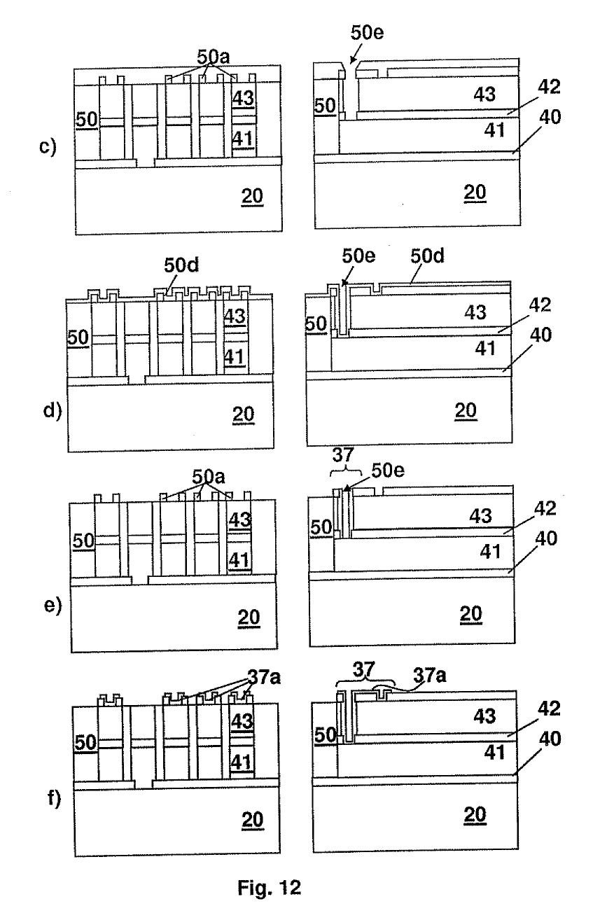

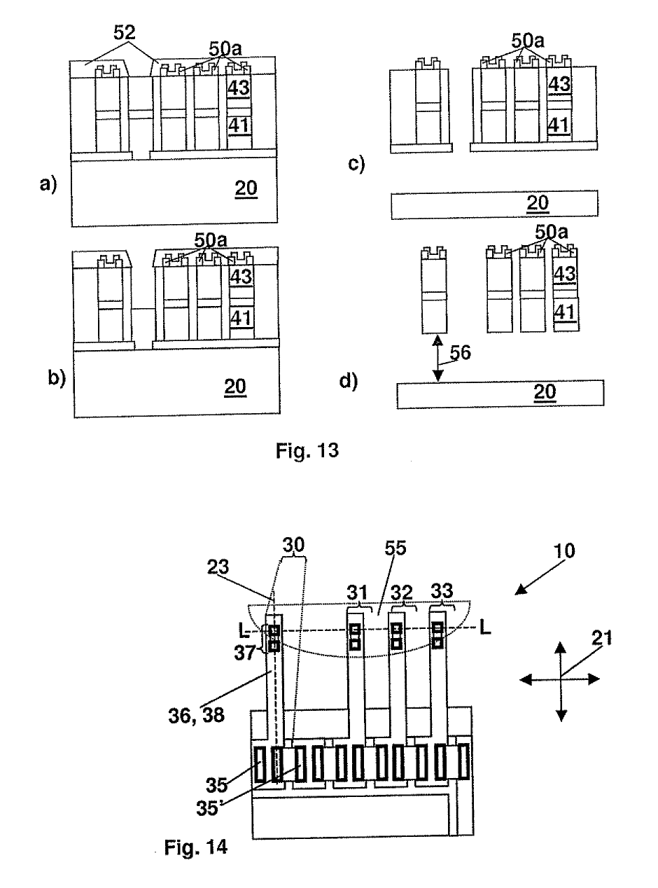

A fourth specific embodiment of micromechanical structure 10 according to the present invention is illustrated in FIGS. 11 through 14, only FIG. 14 or 13d representing finished structure 10 and the remaining figures representing precursor structures of micromechanical structure 10. FIGS. 11a through 11g, 12a through 12f, and 13a through 13d show sectional illustrations along section line L-L from FIG. 14, FIGS. 12a through 12f additionally showing (right figure in each case) sectional illustrations along main extension direction 23 of thermoelement 30 from FIG. 14. Similarly to the first specific embodiment (FIGS. 1 through 3), first insulation layer 40 (FIG. 11b) is also applied to substrate 20 (FIG. 11a) in the fourth specific embodiment. In the fourth specific embodiment—as in the third specific embodiment—first insulation layer 40 is applied in structured form in such a way that an opening remains in first insulation layer 40 at least one point 40a. Corresponding to the first specific embodiment (FIGS. 1 through 3), material 41 proximal to substrate 20 is also applied (FIG. 11c) to first insulation layer 40 (and to substrate 20 in the area of opening 40a) in the fourth specific embodiment. This material is a polysilicon material doped with a first type of charge carrier (i.e., either positive or negative) in particular. Subsequently, a chemical-mechanical polishing step is performed in particular. Similarly to the process steps for the second specific embodiment shown in FIGS. 4d through 4g and 5a through 5f, in the fourth specific embodiment, after the application of material 41 proximal to substrate 20, second insulation layer 42 is deposited (FIG. 11d), material 43 distal from substrate 20 is deposited (FIG. 11e), the etching is performed to structure both material 41 proximal to substrate 20 and also material 43 distal from substrate 20 (FIG. 11f), the filling up using insulating material 50 is performed (FIG. 11g), further insulating material 50a is applied in a structured way (FIG. 12a), lacquer layer 50b is applied (FIG. 12b), plating-through 50e is etched (FIG. 12c), passivation layer 50d is deposited (FIG. 12d) and partially removed (FIG. 12e), and structured contact metal plating 37a, which implements measuring contact 37, is applied (FIG. 12f).

Following this, through etching (for example, using RIE etching (reactive ion etching) or using oxide-RIE etching) through material 43 distal from substrate 20 is performed (FIG. 13b) using a passivation layer 52 (such as a protective lacquer layer), which is only open at the point above point 40a (FIG. 13a), and subsequently—similarly to the method steps described in FIGS. 5i and 8j in regard to the third specific embodiment—etching of a part of substrate 20 is performed (FIG. 13c) and if necessary the material parts (essentially insulation layer 50) remaining between thermoelements 30, 31, 32, 33 are removed (FIG. 13d). This is illustrated in a top view in FIG. 14. Similarly to the first, second, or third specific embodiment (FIG. 2, 7, or 10), a variant with or without support structure 55 (only shown by dashed lines in FIG. 14) is again possible.

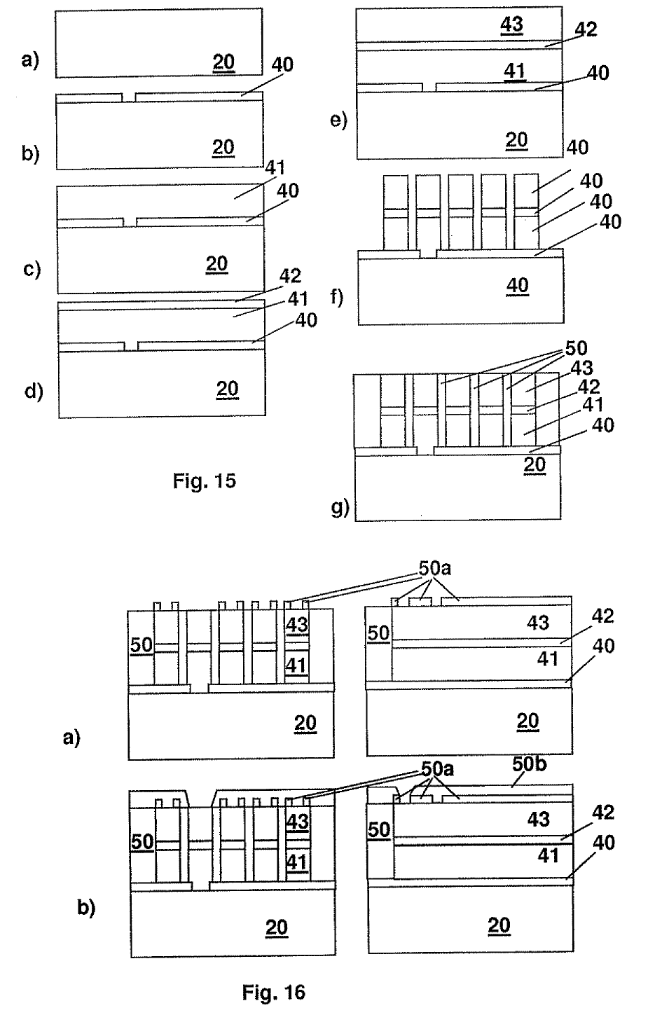

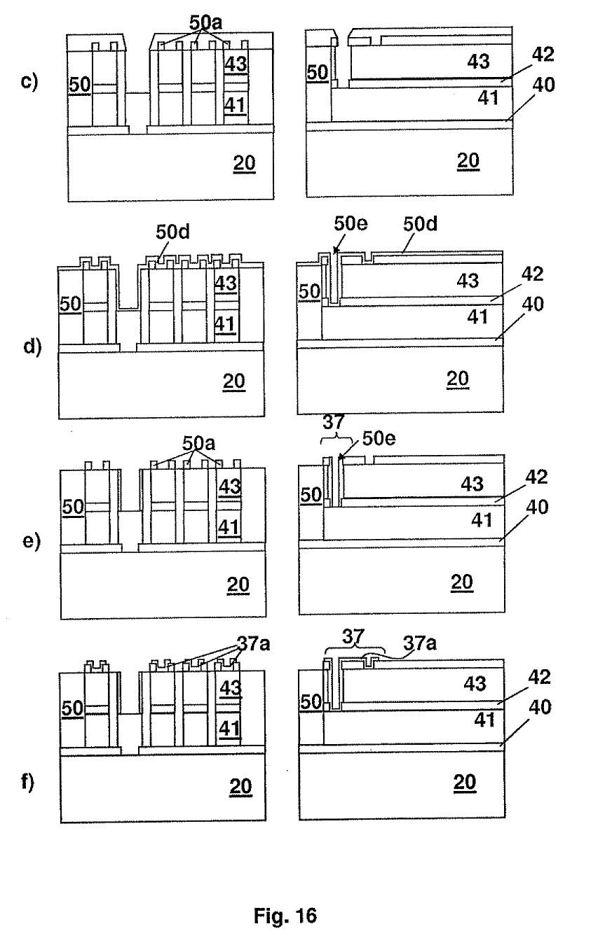

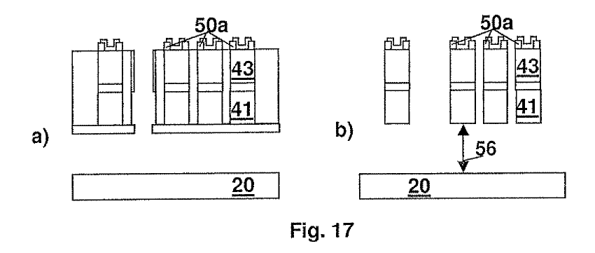

A fifth specific embodiment of micromechanical structure 10 according to the present invention is illustrated in FIG. 15 to 17, only FIG. 17b representing finished structure 10 and the remaining figures representing precursor structures of micromechanical structure 10. FIGS. 15a through 15g, 16a through 16f, and 17a through 17b show sectional illustrations along section line L-L from FIG. 14, FIG. 16a through 16f additionally showing (right figure in each case) sectional illustrations along main extension direction 23 of thermoelement 30 from FIG. 14. FIGS. 15a through 15g and 16a and 16b of the fifth specific embodiment correspond to FIGS. 11a through 11g and 12a and 12b of the fourth specific embodiment, because of which reference is made to the explanations in this regard. In contrast to the method steps shown in FIGS. 12c through 12f of the fourth specific embodiment, the fifth specific embodiment is modified in such a way that the method steps shown in FIGS. 13a and 13b (application of structured passivation layer 52 and through etching (for example, using RIB etching (reactive ion etching) or using oxide-RIE etching) through material 43 distal from substrate 20 may be dispensed with, so that the method according to the present invention may be performed more rapidly and cost-effectively according to the fifth specific embodiment. For this purpose, lacquer layer 50b is structured in such a way (FIG. 16b) that it also exposes material 43 distal from substrate 20 (in contrast to FIG. 12b) above point 40a. During a further etching through material 43 distal from substrate 20 and second insulation layer 42 (FIG. 16c), it is possible to implement not only plating-through 50e, but rather also a preparation for etching a part of substrate 20 corresponding to FIG. 13b. This is also not changed by the further method steps according to FIGS. 16d through 16f, which correspond to the method steps of the fourth specific embodiment of micromechanical structure 10 according to FIGS. 12d through 12f. Therefore, the method steps shown in FIGS. 17a and 17b (or the micromechanical structure in sectional illustrations according to FIG. 17b) correspond to the method steps shown in FIGS. 13c and 13d (or the micromechanical structure in sectional illustration according to FIG. 13d).

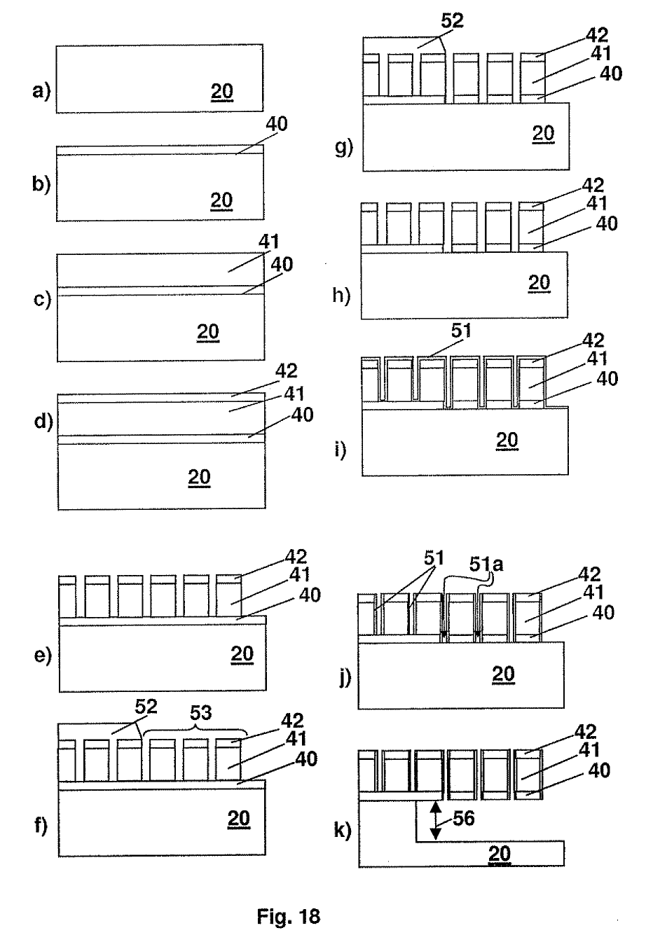

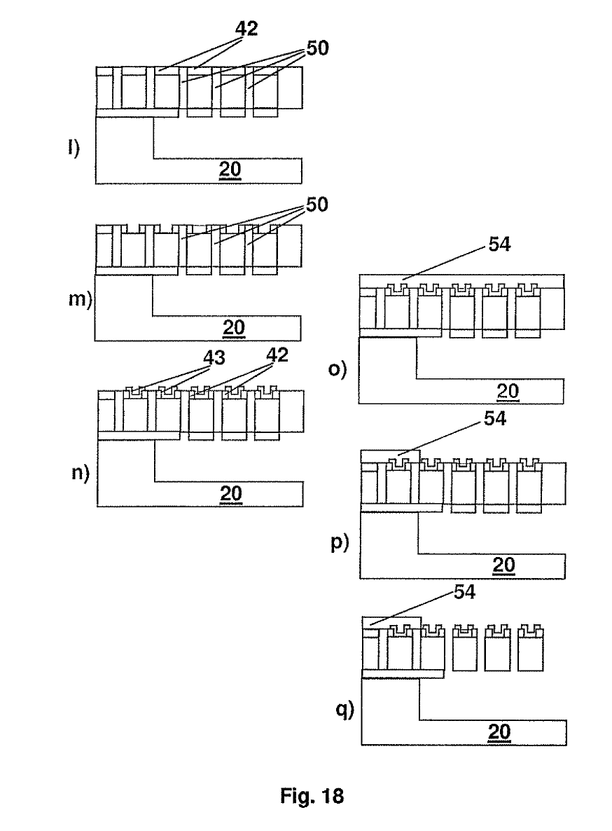

A sixth specific embodiment of micromechanical structure 10 according to the present invention is illustrated in FIG. 18, only FIG. 18n or 18q representing finished structure 10 and the remaining figures representing precursor structures of micromechanical structure 10. FIGS. 18a through 18q generally show sectional illustrations along section line L-L from FIG. 2. Similarly to the first specific embodiment (FIGS. 1 through 3), first insulation layer 40 (such as a silicon oxide layer) is also applied (FIG. 18b) to substrate 20 (FIG. 18a) and material 41 proximal to substrate 20 (FIG. 18c) is applied thereto in the sixth specific embodiment. This material is a polysilicon material doped with a first type of charge carrier (i.e., either positive or negative) in particular. Subsequently, a chemical-mechanical polishing step is performed in particular. Second insulation layer 42, such as a silicon nitride, is deposited (FIG. 18d) on material 41 proximal to substrate 20. Structured etching of material 41 proximal to substrate 20 and second insulation layer 42 is then performed (FIG. 18e). Subsequently, using passivation layer 52 (such as a protective lacquer layer), which is only open at those points (reference numeral 53) at which subsequently a part of substrate 20 is to be etched away (FIG. 18f), first a through etching (for example, using oxide-RIE etching) is performed through first insulation layer 40 (FIG. 18g) and subsequently passivation layer 52 is removed again (FIG. 18h). Similarly to the method steps illustrated in FIGS. 1j through 1l (of the first specific embodiment), passivation layer 51 is subsequently applied to increase the distance between substrate 20 and material 41 proximal to substrate 20, which is opened in a further process step (FIG. 18j) at specific points (cf. reference numeral 51a), for example, using oxide-RIE etching. A part of substrate 20 may then be selectively etched without effects on the previously prepared parts of the micromechanical structure (FIG. 18k). The etching away of a part of substrate 20 in the step according to FIG. 18k may be performed using a ClF₃ etching procedure or a XeF₂ etching procedure, for example. Passivation layer 51 is subsequently removed again and the intermediate spaces etched out between the structures of material 41 proximal to substrate 20 are filled up using insulating material 50, such as oxide or silicon oxide, and the structure is planarized (FIG. 18l). Similarly to the method steps illustrated in FIGS. 1g through 1i (of the first specific embodiment), second insulation 42 is then structured (FIG. 18m) and a material 43 distal from substrate 20 is subsequently applied and structured (FIG. 18n), this material being provided in the form of a metal-plating layer, for example, made of AlSiCu material.

Similarly to the description of the third specific embodiment (FIG. 10 or FIG. 8i), thermoelements 30, 31, 32, 33, 34 are still connected in the direction perpendicular to their main extension direction 23 (and parallel to main extension direction 21 of substrate 20) in this stage of the process sequence (FIG. 18n) of the sixth specific embodiment, which corresponds to a variant of the sixth specific embodiment.

To implement a further variant of the sixth specific embodiment of structure 10 according to the present invention, a further layer (reference numeral 54) made of insulating material, which may be etched selectively to insulating material 50, is applied (FIG. 18o) and structured in such a way (FIG. 18p) that insulating material 50 located between thermoelements 30, 31, 32, 33, 34 is at least partially exposed and may be removed in a subsequent process step (FIG. 18q), for example, using a trench etching process.

1-11. (canceled)

12. A micromechanical structure, comprising:
a substrate having a main substrate plane;
a thermoelement having a reference contact, a measuring contact, a first material between the reference contact and the measuring contact, and a second material between the measuring contact and a further reference contact;
wherein one of i) the first material is situated above the second material, or ii) the second material is situated above the first material, between the reference contact and the measuring contact in a direction perpendicular to the main substrate plane.

13. The micromechanical structure as recited in claim 12, wherein the thermoelement extends at least in some sections parallel to the main substrate plane in a main extension direction between the reference contact and the measuring contact, the micromechanical structure also having multiple thermoelements, the thermoelements being provided at least partially mechanically disconnected from one another perpendicular to the main extension direction.

14. The micromechanical structure as recited in claim 13, wherein measuring contacts of the thermoelements are provided freely suspended.

15. The micromechanical structure as recited claim 13, wherein at least one of: i) measuring contacts of the thermoelements are provided connected to one another like a diaphragm parallel to the main substrate plane, and ii) the measuring contacts of the thermoelements are provided mechanically connected to the substrate in the direction perpendicular to the main substrate plane.

16. The micromechanical structure as recited in claim 12, wherein one of: i) the first material includes a semiconductor material and the second material includes a metal, ii) the first material includes a metal and the second material includes a semiconductor material, or iii) the first material includes a doped semiconductor material and the second material.

17. The micromechanical structure as recited in claim 12, wherein the thermoelement runs diagonally between the reference contact and the measuring contact in relation to the main substrate plane in such a way that the measuring contact is further away from the substrate than the reference contact.

18. A temperature and/or radiation sensor, comprising:
a micromechanical structure, the micromechanical structure including:
a substrate having a main substrate plane;
a thermoelement having a reference contact and a measuring contact;
the thermoelement having a first material between the reference contact and the measuring contact and a second material, between the measuring contact and a further reference contact;
wherein one of i) the first material is situated above the second material, or ii) the second material is situated above the first material between the reference contact and the measuring contact in a direction perpendicular to the main substrate plane.

19. A method for manufacturing a micromechanical structure, comprising:
providing a substrate having a main substrate plane;
providing a thermoelement having a reference contact and a measuring contact, the thermoelement having a first material between the reference contact and the measuring contact, and a second material between the measuring contact and a further reference contact, wherein one of the first material or the second material is provided over the substrate as material proximal to the substrate, and the one of the first material or the second material is provided over the material proximal to the substrate, as material distal to the substrate.

20. The method as recited in claim 19, wherein an insulation layer is at least partially applied between the first and second materials between the application of the material proximal to the substrate and the application of the material distal from the substrate.

21. The method as recited in claim 19, wherein an insulation layer is applied between the substrate and the material proximal to the substrate chronologically before the material proximal to the substrate is applied, the first insulation layer being at least partially removed again chronologically after the material proximal to the substrate is applied.

22. The method as recited in claim 21, wherein at least a part of the substrate adjoining the insulation layer is removed during or after the removal of the insulation layer.
